(19) United States
(12) Patent Application Publication
(10) Pub. No.: US 2023/0399046 A1
(43) Pub. Date: Dec. 14, 2023

(54) APPARATUS FOR USE IN TURNING STEERABLE VEHICLE WHEELS

(71) Applicant: ZF Active Safety and Electronics US LLC, Livonia, MI (US)

(72) Inventors: Michael Dawson, Washington, MI (US); Himadri Kumar Shastry, Washington, MI (US); Ramesh Chirla, Washington, MI (US); Olivier Pugliese, Lebanon, IN (US); Ryan Noerenberg, Washington, MI (US)

(21) Appl. No.: 18/075,461

(22) Filed: Dec. 6, 2022

Related U.S. Application Data
(60) Provisional application No. 63/350,888, filed on Jun. 10, 2022.

(51) Int. Cl. B62D 5/04; B62D 3/06

(52) U.S. Cl. CPC B62D 5/0424; B62D 3/06

(57) ABSTRACT

An apparatus for use in turning steerable vehicle wheels includes a steering member which is axially movable relative to the vehicle to effect turning movement of the steerable vehicle wheels. A ball nut assembly is connected with an externally threaded portion of the steering member. A first motor is connected with the ball nut assembly. The first motor is operable to effect rotation of the ball nut assembly relative to the steering member. A second motor is connected with the ball nut assembly. The second motor is operable to effect rotation of the ball nut assembly relative to the steering member.

### RELATED APPLICATIONS

This application claims priority to U.S. Provisional Application Ser. No. 63/350,888, filed Jun. 10, 2022. The entirety of this provisional application is hereby incorporated by reference for all purposes.

### TECHNICAL FIELD

The present invention relates to an apparatus for use in turning steerable vehicle wheels.

### BACKGROUND

A known vehicle steering apparatus includes a steering member which is axially movable to effect turning movement of steerable vehicle wheels. A ball nut assembly is connected with an externally threaded portion of the steering member. A motor is connected with the ball nut assembly. The motor is operable to effect rotation of the ball nut assembly relative to the steering member.

### SUMMARY

The present invention relates to an apparatus for use in turning steerable vehicle wheels. The apparatus includes a steering member which is axially movable relative to the vehicle to effect turning movement of the steerable vehicle wheels. A ball nut assembly is connected with an externally threaded portion of the steering member. The steering member moving axially in response to rotation of the ball nut assembly relative to the steering member. A first motor is connected with the ball nut assembly. The first motor is operable to effect rotation of the ball nut assembly relative to the steering member. A second motor is connected with the ball nut assembly. The second motor is operable to effect rotation of the ball nut assembly relative to the steering member.

In accordance with one of the features of the present invention, a gear is connected with the ball nut assembly and rotatable with the ball nut assembly relative to the steering member. The first and second motors are operable to effect rotation of the gear and the ball nut assembly relative to the steering member.

In accordance with another feature of the present invention, a first idler gear is in meshing engagement with the gear connected with the ball nut assembly and a second idler gear is in meshing engagement with the gear connected with the ball nut assembly. The first motor is operable to effect rotation of the first idler gear to effect rotation of the gear and the ball nut assembly relative to the steering member. The second motor is operable to effect rotation of the second idler gear to effect rotation of the gear and the ball nut assembly relative to the steering member.

In accordance with another feature of the present invention, a first gear is connected with the ball nut assembly and rotatable with the ball nut assembly relative to the steering member and a second gear is connected with the ball nut assembly and rotatable with the ball nut assembly relative to the steering member. The first motor is operable to effect rotation of a first idler gear in meshing engagement with the first gear connected to the ball nut assembly. The second motor is operable to effect rotation of a second idler gear in meshing engagement with the second gear connected to the ball nut assembly.

In accordance with another feature of the present invention, an electronic control unit controls the first and second motors. At least one motor sensor detects whether at least one of the first and second motors is operating correctly. The ECU adjusts operation of one of the first and second motors if the other of the first and second motors is detected by the at least one motor sensor to not be operating correctly.

In accordance with another feature of the present invention, the first and second motors provide redundancy for each other.

In accordance with another feature of the present invention, the apparatus is a steer-by-wire apparatus.

### BRIEF DESCRIPTION OF THE DRAWINGS

The foregoing and other features of the present invention will become more apparent to those skilled in the art to which the present invention relates upon reading the following description with reference to the accompanying drawings, in which:

FIG. 1 is a schematic pictorial view of a first example of an apparatus for use in turning steerable vehicle wheels constructed in accordance with the present invention;

FIG. 2 is a schematic pictorial view of a portion of the apparatus of FIG. 1 with portions removed to show a gearing for driving a ball nut assembly;

FIG. 3 is schematic sectional view of the portion of FIG. 2;

FIG. 4 is a schematic pictorial view of a portion of a second example of an apparatus for use in turning steerable vehicle wheels constructed in accordance with the present invention with portions removed to show a gearing for driving a ball nut assembly; and

FIG. 5 is a schematic sectional view of the portion of FIG. 4.

### DETAILED DESCRIPTION

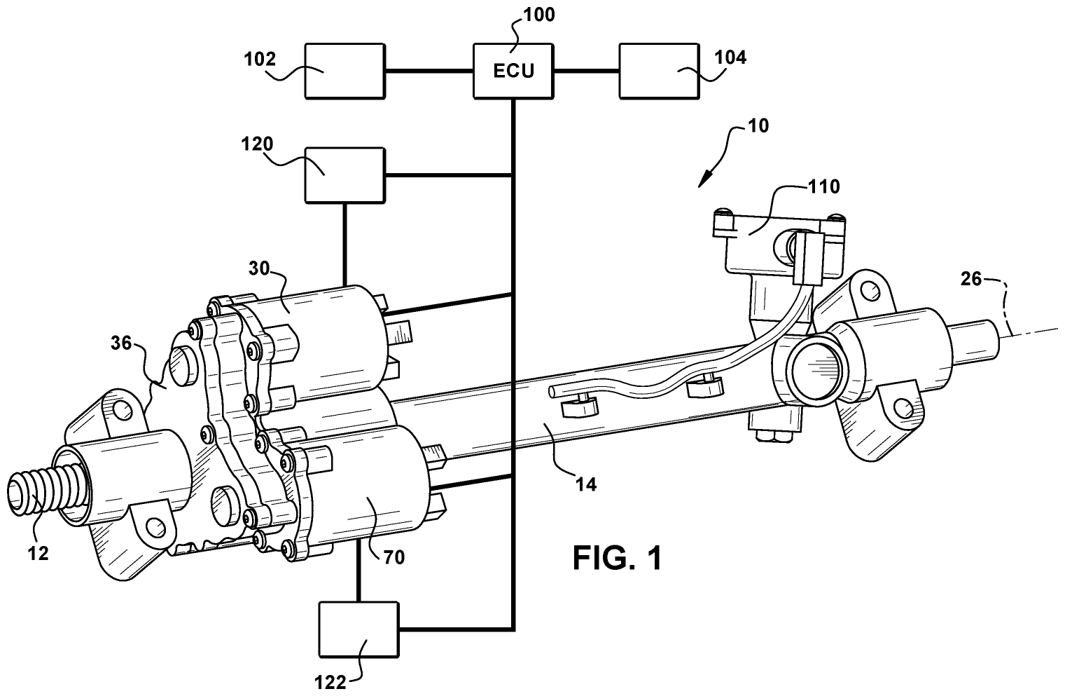

A first example of an apparatus 10 for turning steerable vehicle wheels constructed in accordance with the present invention is illustrated in FIG. 1. The apparatus 10 includes a steering member 12 which is connected to steerable vehicle wheels, as known in the art. A housing 14 supports the steering member 12 for axial or linear movement relative to the housing.

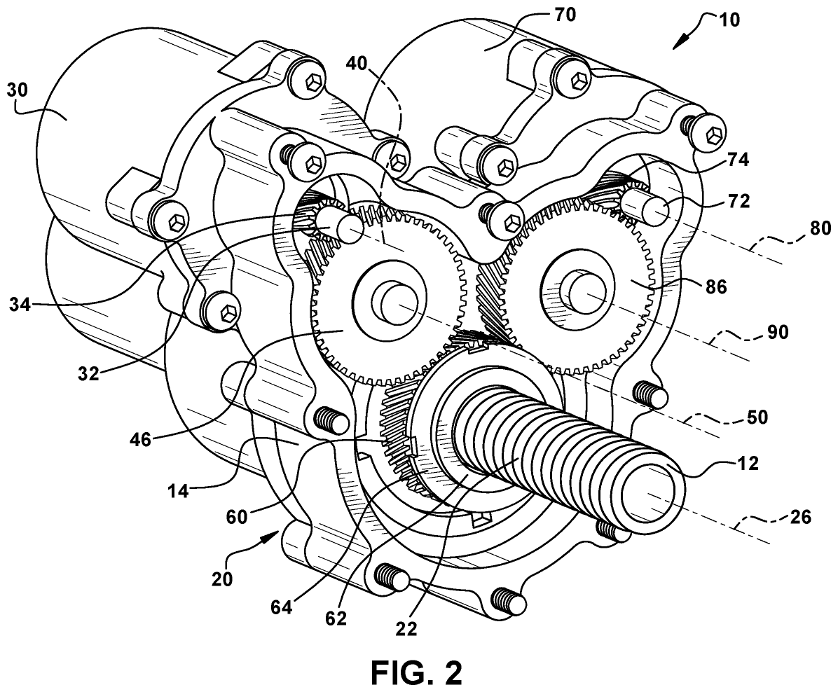

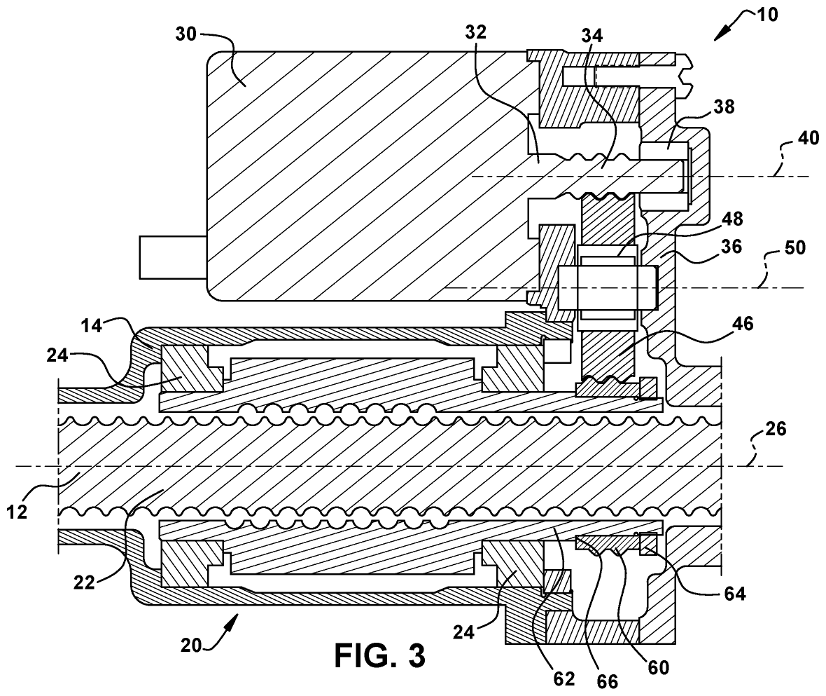

A ball nut assembly 20 (FIGS. 2-3) extends around an externally threaded portion 22 of the steering member 12. Bearings 24 support the ball nut assembly 20 in the housing 14 for rotation relative to the housing and the steering member 12 about a longitudinally extending central axis 26 of the of the steering member. Rotation of the ball nut assembly 20 relative to the steering member 12 is effective to move the steering member axially relative to the housing 14. The housing 14 encloses the ball nut assembly 20 along with at least a portion of the steering member 12.

A first reversible electric motor 30 is operable to rotate the ball nut assembly 20 relative to the steering member 12 and the housing 14. The first electric motor 30 has an output shaft 32 with a first helical drive gear 34. The first helical drive gear 34 may be formed on the output shaft 32 or connected to the output shaft 32. The first helical drive gear 34 and output shaft 32 are supported in a cover member 36 of the housing 14 by a bearing 38. The bearing 38 supports the first helical drive gear 34 for rotation about a longitudinal axis 40 extending generally parallel to the axis 26 of the steering member 12.

The first helical drive gear 34 meshes with a first idler gear 46 to transmit torque from the first motor 30 to the first idler gear. The first idler gear 46 is supported in the cover member 36 of the housing 14 by a bearing 48 for rotation about an axis 50. The axis 50 of the first idler gear 46 extends generally parallel to the axes 26 and 40 of the steering member 12 and first helical drive gear 34.

The first idler gear 46 meshes with a driven gear 60 on the ball nut assembly 20 to transmit torque from the first idler gear to the driven gear. The driven gear 60 is fixedly connected to an axial end portion 62 of the ball nut assembly 20 by a retaining member 64. The retaining member 64 may be an annular member that clamps the driven gear 60 to a shoulder 66 on the axial end portion 62 of the ball nut assembly 20. It is contemplated that the retaining member 64 may threadably engage the axial end portion 62 of the ball nut assembly 20. The first idler gear 46 transmits force to the driven gear 60 from the first motor 30 to rotate the ball nut assembly 20 about the central axis 26 of the steering member 12 during operation of the first motor.

A second reversible electric motor 70 (FIG. 2) is operable to rotate the ball nut assembly 20 relative to the steering member 12. The second electric motor 70 has an output shaft 72 with a second helical drive gear 74. The second helical drive gear 74 may be formed on the output shaft 72 or connected to the output shaft 72. The second helical drive gear 74 and output shaft 72 are supported in the cover member 36 of the housing 14 by a bearing, not shown. The second helical drive gear 74 is supported for rotation about a longitudinal axis 80 extending generally parallel to the axis 40 of the first helical drive gear 34 and the axis 26 of the steering member 12.

The second helical drive gear 74 meshes with a second idler gear 86 to transmit torque from the second motor 70 to the second idler gear. The second idler gear 86 is supported in the cover member 36 of the housing 14 by a bearing, not shown, for rotation about an axis 90. The axis 90 of the second idler gear 86 extends generally parallel to the axes 26 and 80 of the steering member 12 and second helical drive gear 74. The second idler gear 86 meshes with the driven gear 60 on the ball nut assembly 20 to transmit torque from the second idler gear to the driven gear. The second idler gear 86 transmits force to the driven gear 60 from the second motor 70 to rotate the ball nut assembly 20 about the central axis 26 of the steering member 12 during operation of the second motor.

The apparatus 10 (FIG. 1) may be a steer-by-wire apparatus that has no mechanical connection to a steering input member, such as a steering wheel. An electronic control unit (ECU) 100 may control the first and second motors 30, 70. The ECU 100 effects operation of the first and second motors 30, 70 to axially move the steering member 12 relative to the housing 14 to steer the vehicle wheels. The ECU 100 may receive an input signal indicative of a desired path of travel for the vehicle. The ECU 100 may analyze the desired path of travel and operate the first and second motors 30, 70 to axially move the steering member 12 relative to the housing 14 to turn the vehicle wheels a predetermined amount and cause the vehicle to travel along the desired path. The ECU 100 may operate the first motor 30, the second motor 70 or both motors depending on the force necessary to move the steering member 12 the predetermined amount relative to the housing 14.

The apparatus 10 may include vehicle condition sensors 102, 104 for controlling the first and second motors 30, 70 based on sensed vehicle conditions. The vehicle condition sensors 102, 104 may include a torque sensor 102 and a position sensor 104 electrically connected to the ECU 100. The torque sensor 102 may sense torque applied to a steering wheel and generate a signal indicative of the torque. The position sensor 104 may sense the rotational position of the steering wheel and generate an electrical signal indicative of the steering wheel position. The electrical signals from the torque sensor 102 and the position sensor 104 are sent to the ECU 100. The ECU 100 analyzes the output of the sensors 102, 104 and effects operation of the first and second motors 30, 70 as a function of the output of the sensors.

In addition, the ECU 100 may have inputs which vary as a function of sensed lateral acceleration of the vehicle or other vehicle operating conditions. The ECU 100 receives the signals generated by the sensors and actuates the first and second motors 30, 70 in order to apply an axial force to the steering member 12 to turn the steerable vehicle wheels.

A pinion may be in meshing engagement with a rack portion of the steering member 12 such that axial or linear movement of the steering member causes rotation of the pinion relative to a pinion housing portion 110 of the housing 14. In particular, the rack portion includes rack gear teeth disposed in meshing engagement with gear teeth on the pinion, as known in the art. The pinon may help prevent rotation of the steering member 12 relative to the housing 14 about the axis 26 of the steering member.

Sensors may be connected to the pinion housing portion 110 to detect rotational movement of the pinion about the pinion axis. The sensors connected to the pinion may be electrically connected to the ECU 100. The electrical signals from the sensors connected to the pinion are sent to the ECU 100. The ECU 100 analyzes the output of the sensors to determine if the steering member 12 has axially moved the predetermined amount.

The apparatus 10 may also include motor sensors 120, 122 that detect whether the first and second motors 30, 70 are operating correctly. The motor sensors 120, 122 may be electrically connected to the ECU 100. The ECU 100 may analyze the output of the motor sensors 120, 122 to determine if the first and second motors 30, 70 are operating correctly. If the ECU 100 determines that one of the first and second motors 30, 70 is not operating correctly, the ECU 100 may adjust the operation of the other motor to compensate for the motor not operating correctly. Therefore, the first and second motors 30, 70 may provide redundancy for each other.

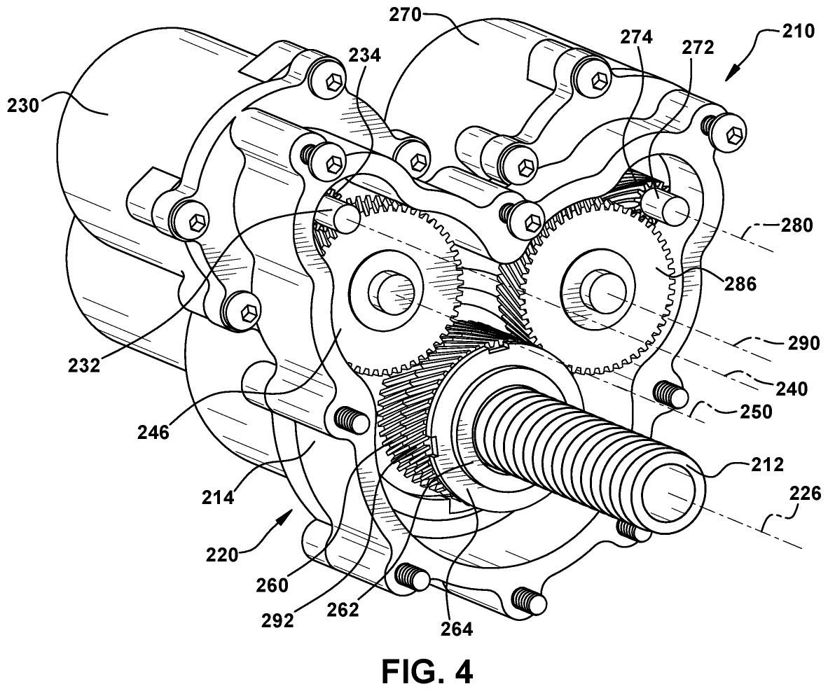

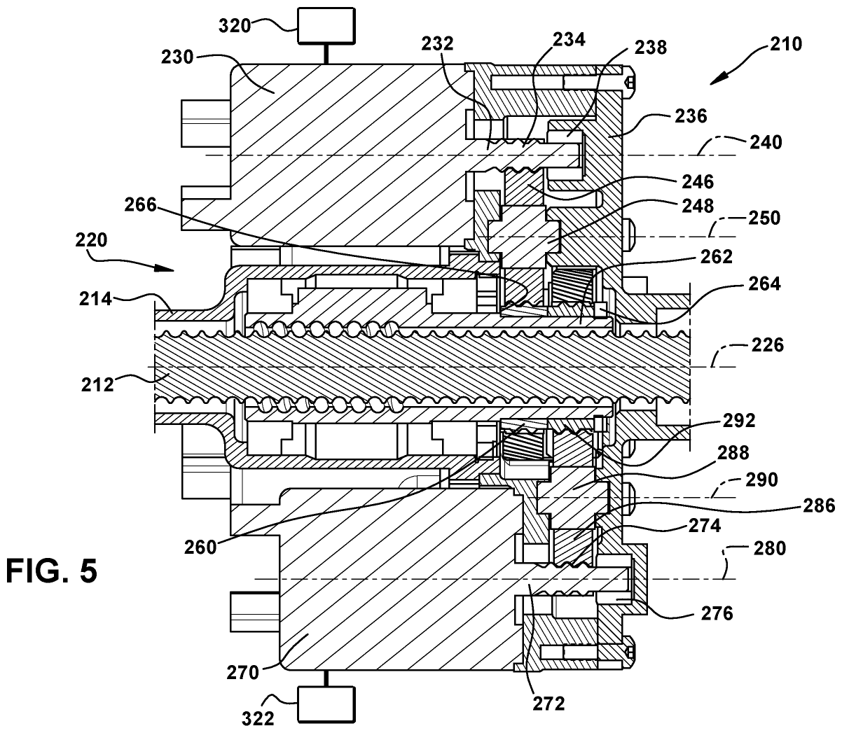

A second example of an apparatus 210 for turning steerable vehicle wheels constructed in accordance with the present invention is illustrated in FIGS. 4-5. The apparatus 210 of FIGS. 4-5 is generally similar to the apparatus 10 of FIGS. 1-3 and, therefore, only the differences will be described in detail.

A first reversible electric motor 230 of the apparatus 210 (FIG. 4) is operable to rotate the ball nut assembly 220 relative to the steering member 212 and the housing 214. The first electric motor 230 has an output shaft 232 with a first helical drive gear 234. The first helical drive gear 234 and output shaft 232 are supported in a cover member 236 of the housing 214 by a bearing 238. The bearing 238 supports the first helical drive gear for rotation about a longitudinal axis 240 extending generally parallel to the axis 226 of the steering member 212.

The first helical drive gear 234 meshes with a first idler gear 246 to transmit torque to the first idler gear 246. The first idler gear 246 is supported in the cover member 236 of the housing 214 by a bearing 248 for rotation about an axis 250. The axis 250 of the first idler gear 246 extends generally parallel to the axes 226 and 240 of the steering member 212 and first helical drive gear 234.

The first idler gear 246 meshes with a first driven gear 260 on the ball nut assembly 220 to transmit torque to the ball nut assembly. The first driven gear 260 is fixedly connected to an axial end portion 262 of the ball nut assembly 220 by a retaining member 264. The retaining member 264 may be an annular member that clamps the first driven gear 260 to a shoulder 266 on the axial end portion 262 of the ball nut assembly 220. It is contemplated that the retaining member 264 may threadably engage the axial end portion 262 of the ball nut assembly 220. The first idler gear 246 transmits force to the first driven gear 260 from the first motor 230 to rotate the ball nut assembly 220 about the central axis 226 of the steering member 212 during operation of the first motor.

A second reversible electric motor 270 is operable to rotate the ball nut assembly 220 relative to the steering member 212. The second electric motor 270 has an output shaft 272 with a second helical drive gear 274. The second helical drive gear 274 and output shaft 272 are supported in the cover member 236 of the housing 214 by a bearing 276. The bearing 276 supports the second helical drive gear 274 for rotation about a longitudinal axis 280 extending generally parallel to the axis 240 of the first helical drive gear 234 and the axis 226 of the steering member 212.

The second helical drive gear 274 meshes with a second idler gear 286 to transmit torque to the second idler gear. The second idler gear 286 is supported in the cover member 236 of the housing 214 by a bearing 288 for rotation about an axis 290. The axis 290 of the second idler gear 286 extends generally parallel to the axes 226 and 280 of the steering member 12 and second helical drive gear 274.

The second idler gear 286 meshes with a second driven gear 292 on the ball nut assembly 220 to transmit torque to the ball nut assembly. The second driven gear 292 is fixedly connected to an axial end portion 262 of the ball nut assembly 220 by the retaining member 264. The retaining member 264 engages the second driven gear 292 so that the second driven gear 292 is axially between the retaining member and the first driven gear 260. The retaining member 264 may clamp the second driven gear 292 and the first driven gear 260 to the shoulder 266 on the axial end portion 262 of the ball nut assembly 220. The second idler gear 286 transmits force to the second driven gear 292 from the second motor 270 to rotate the ball nut assembly 220 about the central axis 226 of the steering member 212 during operation of the second motor.

An ECU may control the first and second motors 230, 270 in a manner similar to the example shown in FIGS. 1-3. The ECU may effect operation of the first and second motors 230, 270 to axially move the steering member 212 relative to the housing 214 to steer the vehicle wheels. The ECU may operate the first motor 230, the second motor 270 or both motors depending on the force necessary to move the steering member 212 relative to the housing 214. Vehicle condition sensors may sense torque applied to a steering wheel and a rotational position of the steering wheel and generate signals indicative of the torque and position. The ECU may effect operation of the first and second motors 230, 270 as a function of the output of the vehicle condition sensors.

A pinion may be in meshing engagement with a rack portion of the steering member 212 such that axial or linear movement of the steering member causes rotation of the pinion relative to a pinion housing portion of the housing 214. In particular, the rack portion may include rack gear teeth disposed in meshing engagement with gear teeth on the pinion, as known in the art. The pinon may help prevent rotation of the steering member 212 relative to the housing 214 about the axis 226 of the steering member. Sensors may detect rotational movement of the pinion about the pinion axis. The ECU may analyze the output of the pinion sensors to determine if the steering member 212 has axially moved.

The apparatus 210 may also include motor sensors 320, 322 that detect whether the first and second motors 230, 270 are operating correctly. The ECU may analyze the output of the motor sensors 320, 322 to determine if the first and second motors 230, 270 are operating correctly. If the ECU determines that one of the first and second motors 230, 270 is not operating correctly, the ECU may adjust the operation of the other motor to compensate for the motor not operating correctly. Therefore, the first and second motors 230, 270 may provide redundancy for each other.

Although the examples of the present invention are shown as a steer-by-wire apparatus, it is contemplated that the pinion may be connected to a steering column that includes a rotatable steering wheel. Upon rotation of the steering wheel, force is transmitted through the steering column to the pinion. The pinion thereby rotates under the influence of force transmitted through the steering column. Due to the meshed engagement between the pinion and the rack portion, rotation of the steering wheel and, thus, rotation of the pinion results in linear movement of the rack portion of the steering member. Accordingly, rotation of the steering wheel results in turning of the steerable vehicle wheels. The first and second motors may apply a force to the steering member through the ball nut assembly to assist in turning of the steerable vehicle wheels.

As can been seen from the above description, the apparatus of the present invention may be used to autonomously steer the vehicle wheels, may be used in a steer-by-wire system or used as a power assist steering system.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. An apparatus for use in turning steerable vehicle wheels, the apparatus comprising:
a steering member which is axially movable relative to the vehicle to effect turning movement of the steerable vehicle wheels;
a ball nut assembly connected with an externally threaded portion of the steering member, the steering member moving axially in response to rotation of the ball nut assembly relative to the steering member;
a first motor connected with the ball nut assembly, the first motor being operable to effect rotation of the ball nut assembly relative to the steering member; and
a second motor connected with the ball nut assembly, the second motor being operable to effect rotation of the ball nut assembly relative to the steering member.

2. An apparatus as set forth in claim 1 further including a gear connected with the ball nut assembly and rotatable with the ball nut assembly relative to the steering member, the first and second motors being operable to effect rotation of the gear and the ball nut assembly relative to the steering member.

3. An apparatus as set forth in claim 2 further including a first idler gear in meshing engagement with the gear connected with the ball nut assembly and a second idler gear in meshing engagement with the gear connected with the ball nut assembly, the first motor being operable to effect rotation of the first idler gear to effect rotation of the gear and the ball nut assembly relative to the steering member, the second motor being operable to effect rotation of the second idler gear to effect rotation of the gear and the ball nut assembly relative to the steering member.

4. An apparatus as set forth in claim 1 further including a first gear connected with the ball nut assembly and rotatable with the ball nut assembly relative to the steering member and a second gear connected with the ball nut assembly and rotatable with the ball nut assembly relative to the steering member, the first motor being operable to effect rotation of a first idler gear in meshing engagement with the first gear connected to the ball nut assembly, the second motor being operable to effect rotation of a second idler gear in meshing engagement with the second gear connected to the ball nut assembly.

5. An apparatus as set forth in claim 1 further including an electronic control unit (ECU) that controls the first and second motors and at least one motor sensor connected with the ECU that detects whether at least one of the first and second motors is operating correctly, the ECU adjusting operation of one of the first and second motors if the other of the first and second motors is not operating correctly.

6. An apparatus as set forth in claim 1 wherein the first and second motors provide redundancy for each other.

7. An apparatus as set forth in claim 1 wherein the apparatus is a steer-by-wire apparatus.
